(19) United States
(12) Patent Application Publication
(10) Pub. No.: US 2024/0356871 A1
(43) Pub. Date: Oct. 24, 2024

(54) GROUP CHAT WITH A CHATBOT

(71) Applicant: Snap Inc., Santa Monica, CA (US)

(72) Inventors: Jason Brewer, Mountain View, CA (US); David Clark Caslin, Baldwin, MD (US); William Spencer Mulligan, Los Angeles, CA (US); Ken Tam, Los Angeles, CA (US); Anirudh Todi, Foster City, CA (US); Samuel Young, Bend, WA (US)

(21) Appl. No.: 18/611,225

(22) Filed: Mar. 20, 2024

Related U.S. Application Data
(60) Provisional application No. 63/460,194, filed on Apr. 18, 2023.

(51) Int. Cl. H04L 51/02; H04L 51/04

(52) U.S. Cl. CPC H04L 51/02; H04L 51/04

(57) ABSTRACT

A system for including a chatbot into a group chat session is provided. The system receives a chatbot mention message from a user in the group chat session. The chatbot mention message includes a chatbot prompt for a chatbot. The system generates a prompt using the chatbot mention message and communicates the response as a chatbot response message to each user in the group chat session.

### CLAIM OF PRIORITY

This application claims the benefit of priority to U.S. Provisional Application Ser. No. 63/460,194, filed on Apr. 18, 2023, which is incorporated herein by reference in its entirety.

### TECHNICAL FIELD

The present disclosure relates generally to interactive platforms and more particularly to providing interaction interfaces to users of an interactive platform.

### BACKGROUND

Users enjoy accessing interactive platforms to share content with other users of the interactive platform. In addition, users enjoy chatting with chatbots.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system that has both client-side and server-side functionality, according to some examples.

FIG. 3A is a block diagram of a chatbot system, according to some examples.

FIG. 3B is a process flow diagram of a chatbot interaction process between a user and a chatbot system, according to some examples.

FIG. 4A is a deployment diagram of components of a group chat system during a group chat session between two or more users and a chatbot, according to some examples.

FIG. 4B is a collaboration diagram of interactions between components of an interactive platform during the group chat session, according to some examples.

FIG. 4C is a process flow diagram of a group chat session, according to some examples.

FIG. 4D and FIG. 4E are illustrations of a user interface during a group chat session, according to some examples.

FIG. 5 illustrates a machine-learning pipeline, according to some examples.

FIG. 6 illustrates training and use of a machine-learning program, according to some examples.

FIG. 7 is a diagrammatic representation of a data structure as maintained in a database, according to some examples.

FIG. 8 is a diagrammatic representation of a message, according to some examples.

FIG. 9 is a flowchart for an access-limiting process, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture, according to some examples.

### DETAILED DESCRIPTION

Interactive platforms (e.g., social platforms, social media platforms, extended Reality (XR) platforms, applications, messaging platforms, XR applications, operating systems, gaming systems or applications, systems with which a user interacts, interaction systems, and the like) may provide a way for users to interact with other users. For some users, interaction with an interactive platform may be enhanced by having a chatbot to interact with. The chatbot can serve multiple uses, including providing a way for a user to generate content for posting to the interactive platform, edit existing content, and receive suggestions in a form of interactive platform postings.

Group chats allow multiple users to communicate in real-time via messaging. However, current group chat systems have some limitations. One issue is that they lack robust tools for users to easily generate and share content during a group chat. For example, if a user wants to create a meme or other image to share with the group, they typically need to exit the chat app, use a separate image editing app, then re-enter the chat to share it. This disrupts the real-time flow of the conversation.

Chatbots operate independently in a one-on-one conversation with a single user. Chatbots lack integration with ongoing group conversations between multiple real users. This is inefficient because chatbots have useful capabilities like generating content or providing information that could benefit a whole group conversation, not just an individual user.

While chatbots can have useful features, they predominantly operate in a one-to-one conversation with a single user. This model is inefficient for group conversations between multiple real users for several reasons. First, the entire group does not benefit from the chatbot's capabilities. For example, if the chatbot provides a useful piece of information to one user, the other users in the group chat do not gain access to that information. In addition, there is no persistence of the chatbot's contributions across the group. For instance, if the chatbot has a relevant conversation with one user, the context and content of that conversation is not maintained for the rest of the group. Additionally, there is no coordination of the chatbot experience in a group chat setting, where multiple users could interact with the chatbot in overlapping or redundant ways without centralized coordination. Finally, the chatbot lacks the full context of the group conversation, limiting its ability to add value without visibility into the entire discussion flow and interests of all the users. Overall, the one-to-one chatbot model introduces fragmentation, prevents the usefulness from being shared, and inhibits integration into the group conversation.

In some examples, a group chat system receives a chatbot mention message from a user system of a user in a group chat session, where the chatbot mention message includes a chatbot prompt created by the user. The group chat system generates a prompt using the chatbot mention message and a chatbot response message using the prompt. The group chat system provides the chatbot response message to one or more other user systems of one or more other users in the group chat session.

In some examples, the group chat system stores one or more stored chatbot mention messages and one or more stored chatbot response messages associated with the user, and generates a context for the prompt using the one or more stored chatbot mention messages.

In some examples, in response to determining, by the group chat system, that the chatbot mention message is a first chatbot mention message in the group chat session, the group chat system provides a chatbot notification describing an operation of the chatbot to one or more users in the group chat session.

In some examples, group chat system generates the response using a persona of the chatbot.

In some examples, in response to receiving, by the group chat system, a delete message request from the user, deleting the one or more stored chatbot mention messages and the one or more stored chatbot response messages.

In some examples, deleting the one or more stored chatbot mention messages and the one or more stored chatbot prompt messages includes immediately deleting the one or more stored chatbot mention messages and the one or more stored chatbot prompt messages from a short-term datastore, and deleting the one or more stored chatbot mention messages and the one or more stored chatbot prompt messages from a long term datastore using a message deletion policy.

In some examples, the one or more stored chatbot mention messages and the one or more stored chatbot response messages are associated with two or more users in the group chat session. The group chat system generates a context for the prompt for each user of the group chat session using the one or more stored chatbot mention messages and the one or more stored chatbot response messages.

Other technical features may be readily apparent to one skilled in the art from the following figures, descriptions, and claims.

### Networked Computing Environment

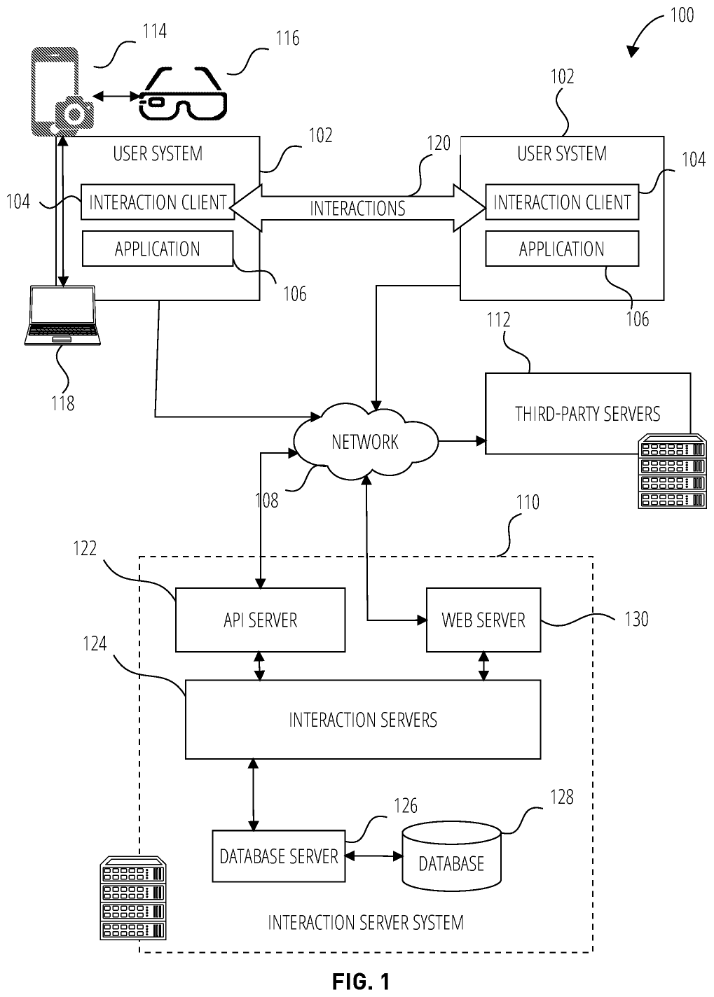

FIG. 1 is a block diagram showing an example interactive platform 100 for facilitating interactions (e.g., exchanging text messages, conducting text audio and video calls, or playing games) over a network. The interactive platform 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interactive platform 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, interactive platform information, and live event information. Data exchanges within the interactive platform 100 are invoked and controlled through functions available via user interfaces (UIs) of the interaction clients 104.

Turning now specifically to the interaction server system 110, an Application Programming (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The API server 122 receives and transmits interaction data (e.g., commands and message payloads) between the interaction servers 124 and the user systems 102 (and, for example, interaction clients 104 and other application 106) and the third-party server 112. Specifically, the API server 122 provides a set of interfaces (e.g., routines and protocols) that can be called or queried by the interaction client 104 and other applications 106 to invoke functionality of the interaction servers 124. The API server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

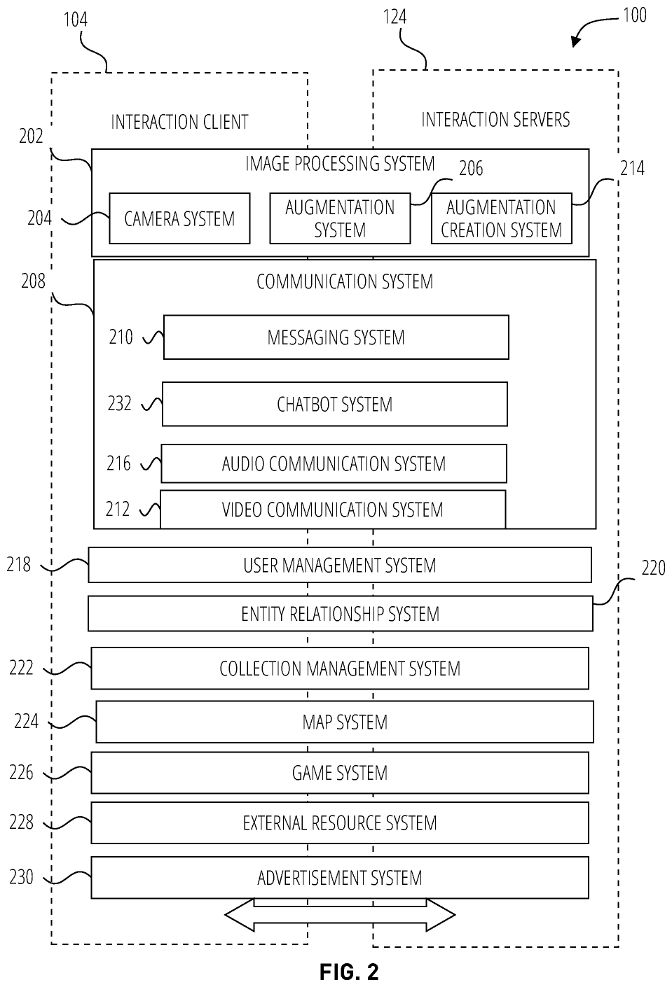

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112 of FIG. 1). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a.*ml file), an applet may incorporate a scripting language (e.g., a.*js file or a .json file) and a style sheet (e.g., a.*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interactive platform 100, according to some examples. Specifically, the interactive platform 100 is shown to comprise the interaction client 104 and the interaction servers 124. The interactive platform 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., augment or otherwise modify or edit) media content associated with a message.

A camera system 204 includes control software (e.g., in a camera application) that interacts with and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102 (of FIG. 1). For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
interactive platform information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interactive platform 100 and includes a messaging system 210, a chatbot system 232, an audio communication system 216, and a video communication system 212. The messaging system 210 is responsible for enforcing the temporary or time-limited access to content by the interaction clients 104. The messaging system 210 incorporates multiple timers within an ephemeral timer system (not shown) that, based on duration and display parameters associated with a message or collection of messages (e.g., a story), selectively enable access (e.g., for presentation and display) to messages and associated content via the interaction client 104. Further details regarding the operation of the ephemeral timer system are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104. The chatbot system 232 is responsible for generating responses to prompts received from a user and communicating a response to the prompt.

A user management system 218 is operationally responsible for the management of user data and profiles, and includes an entity relationship system 220 that maintains interactive platform information regarding relationships between entities that use the interactive platform 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media content and messages by the interaction client 104. For example, the map system 224 enables the display of user icons or avatars (e.g., stored in profile data 702) on a map to indicate a current or past location of “friends” of a user, as well as media content (e.g., collections of messages including photographs and videos) generated by such friends, within the context of a map. For example, a message posted by a user to the interactive platform 100 from a specific geographic location may be displayed within the context of a map at that particular location to “friends” of a specific user on a map interface of the interaction client 104. A user can furthermore share his or her location and status information (e.g., using an appropriate status avatar) with other users of the interactive platform 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interactive platform 100. The interactive platform 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource is authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

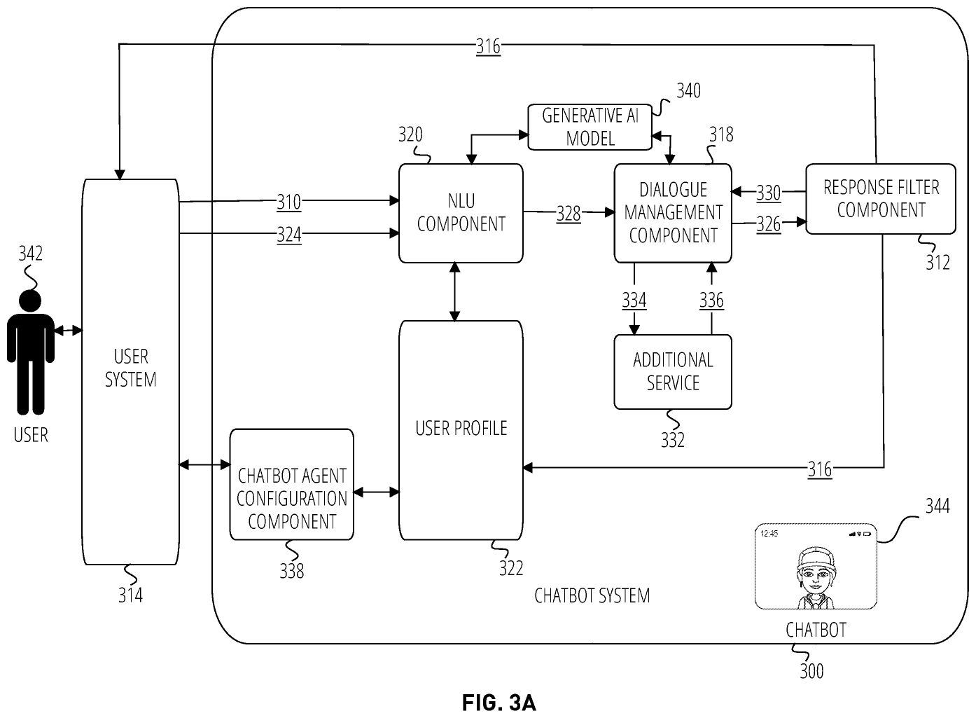

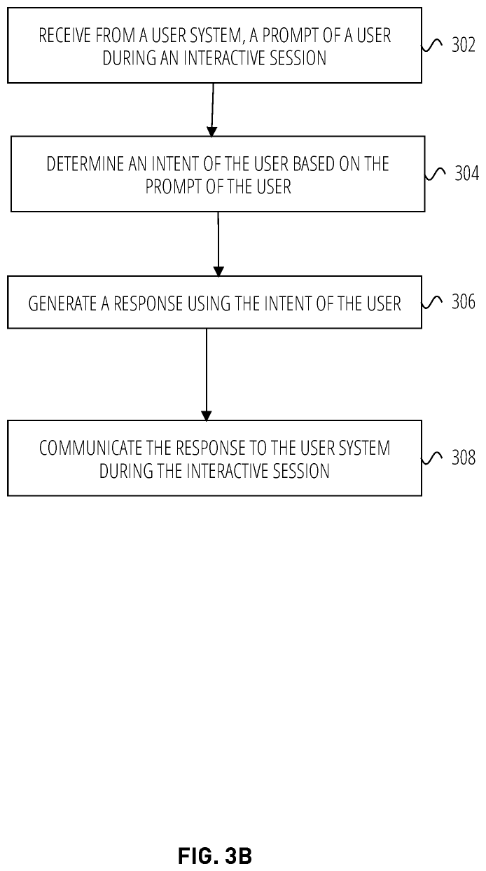

FIG. 3A is a block diagram of a chatbot system 300 implementing a chatbot 344 and FIG. 3B is process flow diagram of a chatbot method, according to some examples. An interactive platform uses a chatbot system 300 to implement a chatbot 344 that interacts with a user 342 of the interactive platform and can be configured by the user 342 to personalize the chatbot 344.

In some examples, the chatbot system 300 is a software platform designed to simulate human conversation through voice commands or text chats. The chatbot system 300 may employ natural language processing (NLP) and machine learning (ML)/artificial intelligence methodologies to understand and interpret the input of the user 342 and generate a response 316.

In some examples, the chatbot's architecture comprises one or more natural language understanding (NLU) components, such as NLU component 320, and one or more dialogue management components, such as dialogue management component 318. The NLU component 320 is responsible for understanding an intent 328 of the user 342 and extracting relevant information from the input of the user, such as prompt 310. This is achieved by analyzing the prompt 310 and mapping it to an intent. The NLU component 320 can use various methodologies such as rule-based systems, statistical models, Large Language Models (LLMs), neural networks, and the like to understand the input of the user. The dialogue management component 318 generates a response 316 to the input of the user. The dialogue management component 318 uses the intent 328 and any extracted information from the NLU component 320 to determine the appropriate response 316. This can be done using rule-based systems, decision trees, statistical models, LLMs, neural networks, and the like. In some examples, the NLU component 320 and the dialogue management component 318 are a single component.

Once the NLU component 320 extracts the relevant information from the prompt 310 as an intent 328 of the user 342, the dialogue management component 318 generates an appropriate response 316. The dialogue management component 318 can generate responses in a human-like manner by using methodologies such as, but not limited to, text generation and machine learning models.

In some examples, either the NLU component 320 or the dialogue management component 318 may use a generative AI model 340, such as a LLM or the like, to improve their natural language understanding and dialogue management capabilities. For example, the NLU component 320 uses the generative AI model 340 to analyze the input of the user and extract relevant information, such as the intent of the user and entities. The dialogue management component 318 can also use the generative AI model 340 to identify and extract important information from unstructured text, such as a question of the user or a request. This can be done using methodologies such as named entity recognition, part-of-speech tagging, sentiment analysis, and the like. In some examples, the NLU component 320 communicates the prompt 310 directly to the generative AI model 340. The generative AI model 340 receives the prompt 310 and generates the response 316. In a similar mater, the dialogue management component 318 may receive the intent 328 and generate a generative AI model prompt that is communicated to the generative AI model 340. The generative AI model 340 receives the generative AI model prompt and generates the response 316.

In operation 302, the chatbot system 300 receives, from a user system 314, a prompt 310 of the user 342 during an interactive session. For example, the user 342 uses user system 314 to access an interactive server that hosts the chatbot system 300. The user 342 enters a prompt, such as prompt 310, into the user system 314 and the user system 314 communicates the prompt 310 to the chatbot system 300. In some examples, the prompt 310 may include other types of data as well as text such as, but not limited to, image data, video data, audio data, electronic documents, links to data stored on the Internet or the user system 314, and the like. In addition, the prompt 310 may include media such as, but not limited to, audio media, image media, video media, textual media, and the like. Regardless of the data type of the prompt 310, keyword attribution and expansion may be used to automatically generate a cluster of keywords or attributes that are associated with the received prompt 310. For example, image recognition may be deployed to identify objects and location associated with visual media and image data and to generate a keyword cluster or cloud that is then associated with the image-based prompt.

The prompt may furthermore be received through any number of interfaces and I/O components (e.g., the I/O components 1008) of a user system 102. These include gesture-based inputs obtained from a biometric component and inputs received via a Brain-Computer Interface (BCI).

In some examples, the chatbot system 300 is integrated into various platforms such as, but not limited to, websites, messaging apps, and mobile apps, allowing users to interact with it through text or voice commands.

In operation 304, the chatbot system 300 determines an intent 328 of the user 342 using the user prompt 310. For example, the NLU component 320 receives the prompt 310 and any user feedback 324 comprising follow up messages from the user 342 and uses an intent processing pipeline to determine the intent 328. This pipeline uses Natural Language Processing (NLP) methodologies to map sets of conversations to a bag of intentful keywords and concepts. In addition to the keywords that are used in the original prompt 310, stemmed keywords and expanded concepts are also generated. The platform also assigns a weight to each concept based on the importance of those in the conversation. These keywords and concepts are aggregated and mapped to the user 342 as part of an intent profile or intent vector having weighted keywords and concepts based on the importance of those in the conversation.

In some examples, the chatbot system 300 associates a time factor to a keyword or concept where the time factor decays in time. For example, the chatbot system 300 attaches a time factor to the keywords and concepts, which indicates how fresh that concept should be used for targeting and bidding. For example, “Hotels in Cancun for spring break” vs “Planning for wedding next year” will have two different decaying factors. In some examples, the chatbot system 300 applies a time factor to a conversation state.

In some examples, an overall intent of the user is built using various signals or data such as user demographics, location, device, engagement with organic surfaces that are user interface and service features provided by the interactive platform, consumption patterns, and overall friend-graph proximity carrier signals or data that may be discernable from the user's affiliation with the interactive platform.

In some examples, the intent vector is an additional dimension that is used to refresh and update an intent profile stored in the user profile 322.

In some examples, the chatbot system 300 uses a user profile 322 that includes one or more datastores of the interactions of the user 342 with the interactive platform.

In some examples, the NLU component 320 uses artificial intelligence methodologies including Machine Learning (ML) models to generate the intent 328. The chatbot system 300 uses the data on intent of the user and conversation context to improve its responses and optimization capabilities over time by ingesting the feedback. The chatbot system 300 collects engagement of the user 342 on ads, organic surfaces (user interfaces and services provided to users by the interactive platform) features of the interactive platforming system and also responses to the chatbot system 300 itself and feeds that into the NLU component 320. Accordingly, the chatbot system 300 can finetune or further pre-train the ML models of the NLU component 320 to not only take intent of the user into consideration, but also use follow up actions to finetune the intent of the user inference model.

In some examples, the chatbot system 300 collects a set of prompts during an interactive session. The chatbot system 300 maps the set of prompts to a set of keywords and/or concepts comprising an intent vector, as exemplified by keywords and concepts. The chatbot system 300 assigns weights to the keywords of the set of keywords and/or concepts based on an importance score to the conversation of the keyword and/or concept and determines the intent of the user based on the intent vector including the weighted keywords and/or concepts.

In some examples, the chatbot system 300 stores a conversation state in a user profile 322 as part of user database of a series of interactive sessions so that the chatbot system 300 can have a context for conversations that occur over a plurality of interactive sessions.

In some examples, a knowledge base of the chatbot system 300 comprises a set of information that the chatbot can use to understand and respond to an input of the user. This includes, but is not limited to, a predefined set of intents, entities, and responses, as well as external sources of information such as databases or APIs. In some examples, intent information of a friend, or friends, of the user 342 are used to understand, inform, and/or respond to a user's intent.

In operation 306, the chatbot system 300 uses a dialogue management component 318 to generate a response 316 using the intent 328. For example, the dialogue management component 318 receives the intent 328 and communicates the intent 328 as a Generative AI model prompt to the generative AI model 340. The generative AI model 340 receives the Generative AI model prompt and generates the response 316. The generative AI model 340 communicates the response 316 to the dialogue management component 318. The dialogue management component 318 receives the response 316 and communicates the response 316 to the response filter component 312 for additional processing. In some examples, the dialogue management component 318 generates the response 316 using a set of additional services 332, such as, but not limited to, an image generation system. The dialogue management component 318 generates a service request 334 using the intent 328 and communicates the service request 334 to the additional service 332. The additional service 332 uses the service request 334 to generate the request response 336 and communicates the request response 336 to the dialogue management component 318. The dialogue management component 318 uses request response 336 to generate the response 316.

In some examples, the chatbot system 300 uses a response filter component 312 to filter a raw response 326 generated by the dialogue management component 318. For example, the dialogue management component 318 communicates the raw response 326 to the response filter component 312 and the response filter component 312 filters the raw response 326 based on a set of filtering criteria to eliminate specified content from the raw response 326, for instance obscene words or concepts, or content that some may consider harmful. In some examples, the response filter component 312 generates an adjusted intent 330 based on filtering the raw response 326, and the dialogue management component 318 generates an additional raw response 326 using the adjusted intent 330.

In some examples, the generative AI model 340 and the additional service 332 are hosted by the same system that hosts other components of the chatbot system 300. In some examples, the generative AI model 340 and the additional service 332 are hosted by a server system that is separate from the system that hosts the chatbot system 300, and the chatbot system 300 communicates with the generative AI model 340 and the additional service 332 over a network. For example, the chatbot system 300 receives the prompt 310 and communicates the prompt 310 to the generative AI model 340 residing on the separate server system. The generative AI model 340 receives the prompt 310 and generates a raw response 326. The generative AI model 340 then communicates the raw response 326 to the chatbot system 300. The chatbot system 300 receives the response for subsequent processing as described herein.

In some examples, as part of the response 316, the chatbot system 300 generates a set of chatbot system prompts that are displayed to the user 342 by the user system 314 that prompt the user 342 to interact with the chatbot system 300. The chatbot system prompts generated by the chatbot system 300 may include chat information such as, but not limited to, context sensitive material, instructions to the user 342, possible topics of conversation, and the like. In some examples, the chatbot system 300 uses the chatbot system prompts to suggest chat topics to a user 342 or to guide the user 342 through a conversation, such as providing instructional material on various topics. In some examples, the chatbot system prompts comprise suggestions of conversations or questions that are intended to solicit a user 342 to enter a prompt of the user 342. The suggested chats are aimed at helping the user 342 get to information they need but provide a helpful side effect of generating additional user interactions with the chatbot system 300. These additional user interactions improve the ability of the chatbot system 300 to determine user intent by providing additional context and information to the chatbot system 300.

In some examples, the chatbot system 300 determines a personality or tone for the responses generated by the chatbot system 300. For example, the chatbot system 300 stores a conversation state for the user 342 as part of the user's profile stored in the user profile 322. The chatbot system 300 uses the conversation state and demographic or other information about the user 342 to determine a personality or tone for the user 342, such as by adopting a formal tone for an older user, and a more informal tone for a younger user.

In some examples, the user 342 specifically alters the “persona” of interactions with the chatbot system by interacting with a chatbot agent configuration component 338 and specifically requesting that the chatbot system 300 respond or act in a specific way (e.g., “be funnier”, “answer in riddles” etc.). In addition to modifying the personality or tone of the responses, the visual interface presented by the chatbot system 300 may also be altered to reflect a specific “persona” of the chatbot system 300. In some examples, a slide toggle may be presented to enable the user 342 to select between a menu of persona traits (e.g., “cheeky”, “wry”, “cute”, etc.)

In operation 308, the chatbot system 300 communicates the response 316 to the user system 314. The user system 314 receives the response 316 and provides the response 316 to the user 342.

In some examples, the system that hosts the chatbot system 300 may not be a component of an interactive platform but another interaction system that provides services and information to a group of users such as, but not limited to, a platform that provides enterprise wide connectivity to a group of users such as employees of a company, clients of an enterprise provided professional services, educational institutions, and the like. In some of such examples, the content provided to the users may not be advertising but may be other types of useful information such as company policies, status messages for projects, newsworthy events, and the like.

In some examples, the chatbot system 300 is operatively connected to an Internet search engine using the additional service 332 or the like and a user can use the chatbot system 300 as an intelligent search engine to search the Internet.

In some examples, the chatbot system 300 is operatively connected to a proprietary database via the additional service 332 and a user can use the chatbot system 300 as an intelligent search assistant for searching the proprietary database.

In some examples, machine learning components of the NLU component 320, the dialogue management component 318, and the generative AI model 340 are continuously retrained or finetuned based on user interactions with the response 316. For example, interactions by a user with the response 316 are stored in an analytics database (not shown). Metrics of the interactions are then used to provide reinforcement to the dialogue management component 318 when the dialogue management component 318 provides a sequence of responses that lead to a successful intent 328 determination and consequently a properly targeted response 316.

In some examples, the chatbot system 300 uses conversations between users and other chatbots as inputs into the NLU component 320 and/or the dialogue management component 318. The other chatbots can be sponsored chatbots, custom chatbots built by users from self-serve tools/templates, and the like.

In some examples, the information that the chatbot system 300 extracts from conversations is focused on the intent of the user. In addition, the chatbot system 300 furthers a conversation with a user by knowing that intent of the user (e.g., if the user asks for good hotels in Cancun, the chatbot system 300 responds with: “Here is a list of hotels. I also know of a good promotion for a hotel, would you like to see it?”). This provides for the intent of the user being extracted from the user, matching the intent to other content, and embedding that content into the response 316. In some examples, textual components of the additional content are used to finetune the responses of the intent 328 determined by the NLU component 320 and/or the response 316 generated by the dialogue management component 318. This improves the suggestions provided by the chatbot system 300 and improves user engagement.

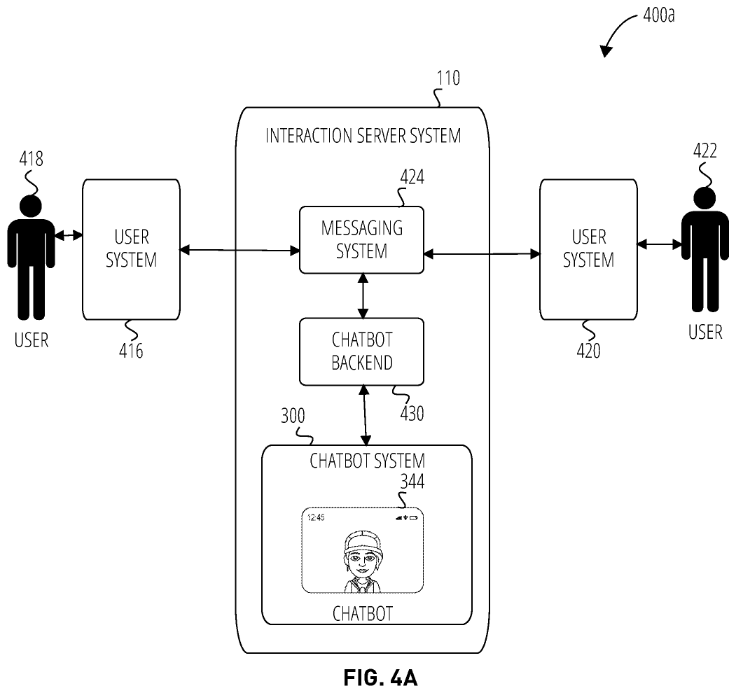

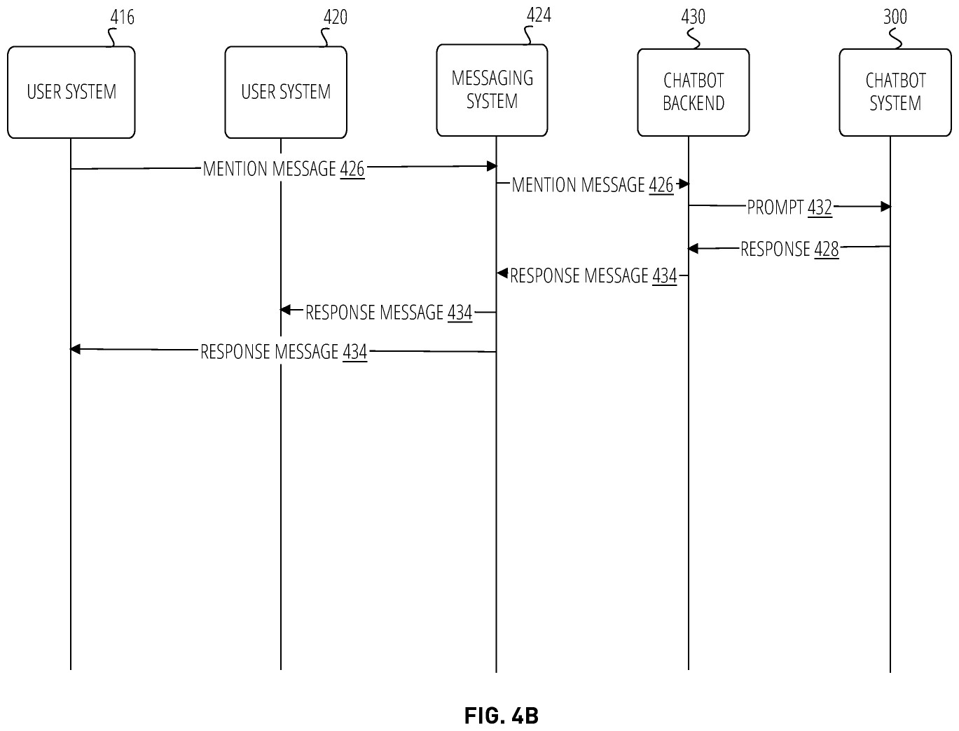

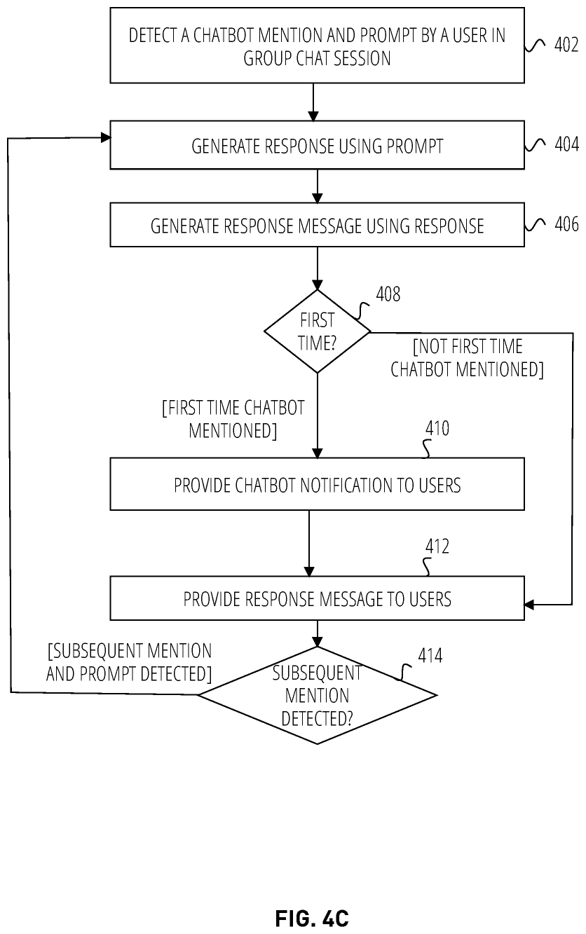

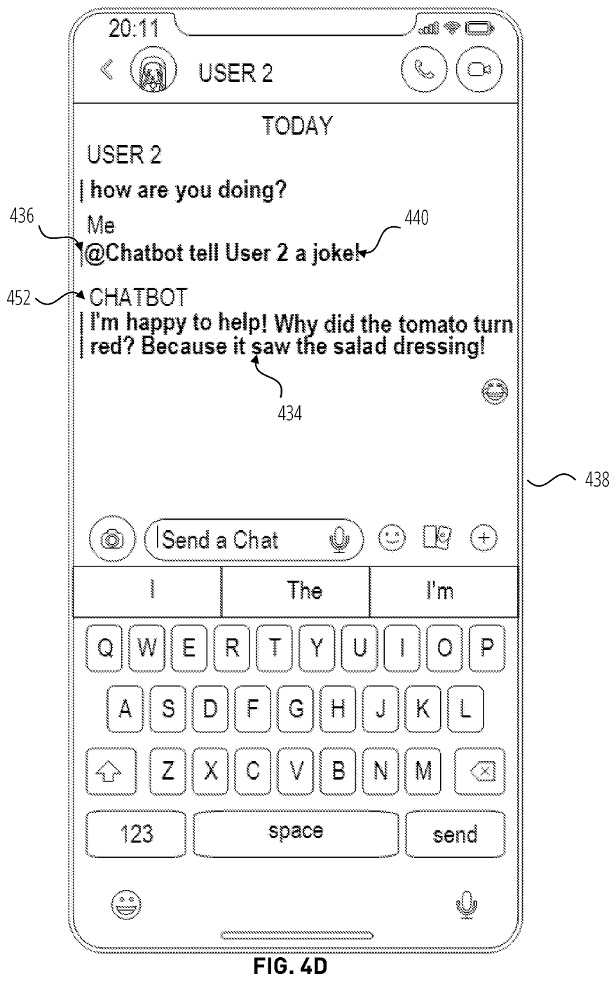

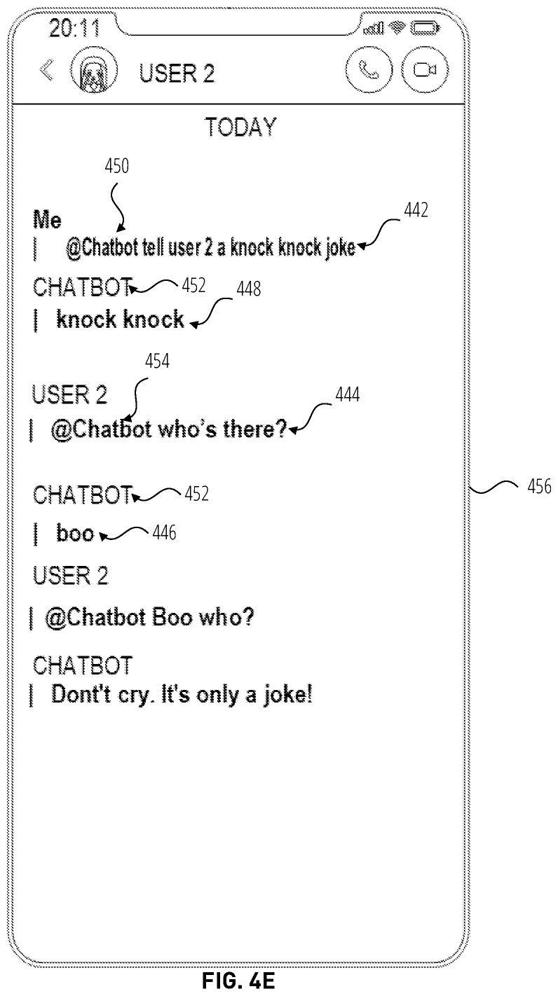

FIG. 4A is a deployment diagram of components of a group chat system during a group chat session between two or more users and a chatbot, FIG. 4B is a collaboration diagram of interactions between components of an interactive platform during the group chat session, FIG. 4C is a process flow diagram of the group chat session, and FIG. 4D and FIG. 4E are illustrations of a user interface during the group chat session, according to some examples. A group chat system 400a allows two or more users, such as user 418 and user 422, to use respective user systems, such as user system 416 and user system 420, to access an interaction server system 110 and conduct a group chat session. During the group chat session, one or more of the users may invite a chatbot 344 into the group chat session. The interaction server system 110 uses a chatbot system 300 of the interactive platform 100 to implement the chatbot 344. The chatbot system 300 uses a messaging system 424 of the interaction server system 110 to enter into the group chat session.

In operation 402, a user system, such as user system 416 detects a request from a user in the group chat session for inclusion of a chatbot 344 in the group chat session. For example, the user system 416 detects that a user has entered a chatbot mention 436 (of FIG. 4D) of the chatbot 344 into a group chat chatbot user interface 438 of a user system. In response to detecting the chatbot mention 436, the interaction server system 110 determines if the chatbot 344 is already part of the group chat session. In response to determining that the chatbot 344 is not already part of the group chat session, the interaction server system 110 interprets the chatbot mention 436 as a request by the user to include the chatbot 344 in the group chat session.

In some examples, the interaction server system 110 enables a user to condition the inclusion of a chatbot in a group chat session based on agreement by all other participants. When the user system 416 detects a chatbot mention by the user in a group chat session, before generating a chatbot mention message, the interaction server system 110 checks if the user has specified that chatbot inclusion requires agreement.

If agreement is required, the interaction server system 110, via the user system 416, prompts the other participants in the group chat session to approve including the chatbot. The interaction server system 110 only processes the chatbot mention message if explicit agreement is received from all participants.

In some examples, a user can specify this agreement requirement in advance when establishing the group chat. In this case, the interaction server system 110 checks that all participants agreed to potential chatbot inclusion when joining the group chat. If so, the interaction server system 110 will automatically process the chatbot mention message without additional prompting when it detects a chatbot mention. If agreement is not required, the interaction server system 110 directly processes the chatbot mention message without confirmation from other users. This allows the requesting user to unilaterally include the chatbot.

In operation 404, the user system 416 generates a mention message 426 using the chatbot mention 436 and a chatbot prompt 440 (of FIG. 4D) and communicates the mention message 426 to the messaging system 424 indicating that a user has requested that a chatbot join the group chat session. For example, the user system 416 annotates the mention message 426 with the fact that the chatbot 344 was mentioned during the group chat session by a user. In addition, the mention message 426 comprises the chatbot prompt 440 (of FIG. 4D) that was entered by the user when the user mentioned the chatbot 344. In some examples, the mention message 426 comprises a user id of the user that mentioned the chatbot 344. The user system 420 uses an Application Programming Interface (API) of the interaction server system 110 to send the mention message 426 message to the messaging system 424.

In operation 406, the chatbot system 300 generates a response to the chatbot prompt 440 in the mention message 426. For example, the messaging system 424 receives the mention message 426 and calls a chatbot backend 430 with the mention message 426.

In some examples, the mention message 426 includes an @mention flag on and the messaging system 424 stores the flag that indicates the message was @mentioned. In some examples, the messaging system 424 stores one or more mention messages 426 in an indexable datastore so that the other components of the interaction server system 110 may perform a query against the stored one or more mention messages 426.

The chatbot backend 430 generates a prompt 432 using the mention message 426 and the chatbot prompt 440 entered by the user. The prompt 432 comprises the chatbot prompt 440.

In some examples, the chatbot backend 430 provides additional information of a context of the chatbot prompt 440. For example, the chatbot backend 430 stores various inputs and output parameters into a short-term storage and a long term storage that are useful for training a generative AI model in order to improve the chatbot system 300's responses over time.

In some examples, the chatbot backend 430 receives new requests forwarded by the messaging system 424, keeping track of the group chat session history, and formulates prompts that are communicated to the chatbot system 300.

In some examples, the chatbot backend 430 stores all chatbot mention messages, respective users that originate the chatbot mention messages, and respective chatbot response messages during group chat session. The chatbot backend 430 generates a context for each user's interactions with the chatbot 344 during the group chat session using each user's chatbot mention messages and respective chatbot response messages.

In some examples, one or more users in the group chat session personalize the chatbot 344 by defining a persona of the chatbot 344 as described in FIG. 3A. In addition, each chatbot mention message comprises a user identification of a user that originated the chatbot mention message. The chatbot backend 430 uses the user identification to determine a persona that the originator of the chatbot mention message defined for the chatbot 344. The chatbot backend 430 communicates the persona to the chatbot system 300 and the chatbot system 300 generates the response 428 further using the persona that was defined by the user that originated the chatbot mention message.

In some examples, the chatbot backend 430 uses the short-term storage to store group chat session data such as, but not limited to: a user identification of each user in the group chat session; each received and sent message; a timestamp for each message; metadata about which model, parameters where used for generating the response; and keywords that are extracted from each message which could aid in determining conversation context.

In some examples, after a message is no longer relevant to a current conversation, the chatbot backend 430 moves that data to long term storage in a long term storage location that facilitates offline processing of that data. In some examples, the short-term storage and long term storage are used as data sources for pre-training and finetuning a generative AI model of the chatbot system 300.

In some examples, the stored data is used for: ingestion by a user profile service to augment the platform's understanding of the user's interests; used by a discovery or monetization platform for aid in ranking; using previous conversations to learn the user's interests, preferences, and leverage in future conversations to make the chatbot system 300 more personalized.

In some examples, when a user sends in a chatbot mention message, as a preliminary filter, the chatbot backend 430 performs keyword detection for any subject matter that the platform considers sensitive. In some examples, the chatbot backend 430 includes a set of platform policies for content filtering that is based on geography and/or local legal systems.

In some examples, the chatbot backend 430 does not store conversations on specified topics.

In some examples, the chatbot backend 430 attaches metadata to a chatbot prompt or chatbot system 300 response. For example, a specified number of previous messages in a conversation can be sent to the chatbot system 300 as part of a user prompt. This provides the chatbot system 300 a context on questions that are “follow ups” to previous topics. For example, if a user asks for restaurants in LA, then says “what about bars”, the chatbot system 300 leverages the location data from previous question to suggest bars in LA.

In some examples, the chatbot system 300 generates a stateful conversation based on conversation histories stored in the short-term storage and the long term storage. Much like a real user would have their conversation history visible to them as they type messages to a friend, the chatbot system 300 accesses previous messages in a conversation in order to understand the context for the most recent message.

Any conversation history collected by a chatbot system 300 is captured and stored only with user approval and deleted on user request. Further, such data may be used for very limited purposes, such as prompting a generative AI model. To ensure limited and authorized use of conversation history data, access to this conversation history data is restricted to authorized personnel only, if at all. Any use of conversation history data may strictly be limited to a designated purpose, and the conversation history data is not shared or sold to any third party without the explicit consent of the user. In addition, appropriate technical and organizational measures are implemented to ensure the security and confidentiality of this sensitive information.

In some examples, the chatbot system 300 enables multiple users in a group chat session to interact with the chatbot in a contextual flow of a conversation of a group chat. For example, a first user can generate a first prompt to the chatbot by mentioning it in the group chat. The chatbot system 300 creates a response to that first prompt using natural language processing. Then, a second user can follow up by mentioning the chatbot again and providing a second prompt that builds on context based on the conversation history established by the first prompt and response. When generating the response to this second prompt, the chatbot system 300 refers back to the stored conversation history from the first prompt and response, allowing the chatbot system 300 to create a response that comprehends the conversational flow across multiple users. In this way, the chatbot system 300 can maintain context and stateful conversation throughout a group chat session, even as different users mention the chatbot and contribute prompts in a collaborative, interactive way. The chatbot responses remain coherent and part of a continuous conversation using the context created from the chat history across all users in the group.

In some examples, the chatbot system 300 may not be re-trained based on previous conversations. As such, the chatbot system 300 does not “remember” previous messages in the conversation in the event the conversation is set to be deleted after viewing by a user.

In some examples, in order to replicate the concept of “memory” for the 300, the chatbot system 300 retains a copy of each message regardless of a message deletion policy that is applied to the conversation. For example, the chatbot system 300 retains a specified number of messages, or retains messages based on a specified time period (e.g., 10 messages and/or 30 minutes of conversation).

In some examples, the group chat system 400a builds a history of mentioned messages across all users in the group chat session.

In some examples, an interaction server system 110 pre-trains the chatbot system 300 on details of the interaction server system 110.

In some examples, the chatbot 344 is pre-trained to feel like a real user in respects to how it will “read” chat messages, and show presence and typing indicators when interacting with users on the platform.

In operation 406, the chatbot system 300 generates a response 428 using the prompt 432. For example, the chatbot backend 430 communicates the prompt 432 to the chatbot system 300. The chatbot system 300 receives the prompt 432 and generates a response 428 as described in reference to FIG. 3A. The chatbot system 300 communicates the response 428 to the chatbot backend 430 and the chatbot backend 430 receives the response 428.

In some examples, the chatbot backend 430 logs the mention message 426 and the response 428 into a short-term datastore. In some examples, stored data of the response 428 includes a source column that identifies that the stored response 428 was from a mention in a group chat session as opposed to a 1:1 conversation between a user and the chatbot 344.

In some examples, the chatbot backend 430 communicates the prompt 432 and the response 428 to a monetization component of the interaction server system 110.

In operation 408, the chatbot backend 430 determines if a current mention of the chatbot 344 is a first mention of the chatbot 344 during the group chat session using the mention message 426 and/or the response 428. For example, the chatbot backend 430 stores incoming mention messages 426 and respective outgoing responses 428 in a short-term datastore during the group chat session. The chatbot backend 430 consults the short-term datastore to determine that a current mention message 426 and/or a current response 428 is the first mention message 426 and/or response 428 in the group chat session.

In response to determining that the current mention of the chatbot 344 is the first mention of the chatbot 344, in operation 410, the chatbot backend 430 provides a chatbot notification message to the users of the group chat session. For example, the chatbot backend 430 generates a chatbot notification message indicating that the chatbot 344 is about to enter the group chat session and communicates the chatbot notification message to the user systems, such as user system 416 and user system 420, of all of the users, such as user 418 and user 422, participating in the group chat session via the messaging system 424.

In some examples, the group chat system 400a provides an opt-out option to a user allowing the user to exit the group chat session. In some examples, the opt-out option includes an option to allow a user to prevent user information of the user to be communicated to the chatbot system 300 during the group chat session.

In some examples, the chatbot notification message comprises information about what the chatbot 344 is, how the chatbot 344 behaves, and how the interaction server system 110 uses user data. In some examples, the chatbot backend 430 tracks whether any @mention has occurred, and whether each user has seen the chatbot notification message. In some examples, provision of the chatbot notification message is tracked by the chatbot backend 430 on a per-group group chat session basis. In some examples, provision of the chatbot notification message is tracked on a per-user basis. When on a per-user basis, the chatbot backend 430 tracks each user in each group chat session because users can be added to group chat sessions at any point in time and may have never seen the chatbot notification message for that conversation.

The chatbot backend 430 transitions to operation 412 when the chatbot notification to the users is completed.

In operation 408, in response to determining that the current mention of the chatbot 344 is not the first mention of the chatbot 344, the chatbot backend 430 transitions to operation 412.

In operation 412, the chatbot backend 430 provides the response 428 to the users in the group chat session. For example, the chatbot backend 430 generates a response message 434 using the response 428. The chatbot backend 430 communicates the response message 434 to the messaging system 424. The messaging system 424 receives the response message 434 and communicates the response message 434 to each of the users, such as user 418 and user 422, in the group chat session. The respective user systems of the users, such as user system 416 for user 418 and user system 420 for user 422, receive the response message 434 and provides the response message 434 to the respective users in a group chat chatbot user interface, such as group chat chatbot user interface 438 (of FIG. 4D). The response message 434 is provided along with a chatbot presence indicator 452 indicating that the chatbot 344 has entered the group chat session.

In operation 414, a user system, such as user system 416 or user system 420, determines if a subsequent mention of the chatbot 344 has been made in the group chat session by one of the users. In response to detecting a subsequent mention of the chatbot 344, the group chat system 400a continues operations at operation 404.

For example, in reference to FIG. 4E, a user system, such as user system 416, of a user in the group chat session, such as user 418, detects an initial chatbot mention 450 and a chatbot prompt 442 as described in operation 402 of FIG. 4C. In response, the group chat system 400a generates an initial chatbot response 448 and provides the initial chatbot response 448 to the users in the group chat session as described in operation 404, operation 406, operation 408, operation 410, and operation 412 of FIG. 4C. In response to detecting a subsequent chatbot mention 454 and subsequent chatbot prompt 444, the user system 416 generates a subsequent mention message and communicates the subsequent mention message to the messaging system 424. The messaging system 424 receives the subsequent mention message and calls the chatbot system 300 with the subsequent mention message as described in reference to FIG. 4C. The chatbot backend 430 receives the subsequent mention message, generates a subsequent prompt and communicates the subsequent prompt to the chatbot system 300 as described in reference to FIG. 4C. The chatbot system 300 receives the subsequent prompt, generates a subsequent chatbot response 446, and returns the subsequent chatbot response 446 to the chatbot backend 430 as described in FIG. 4C. The chatbot backend 430 receives the subsequent chatbot response 446, generates a subsequent response message, and provides the subsequent response message to the user systems of the users participating in the group chat session, such as user system 416 and user system 420, as described in FIG. 4C. The user systems receive the subsequent response message and provide the subsequent chatbot response 446 to the users in the group chat session in display of a group chat chatbot user interface 456 as described in FIG. 4C.

In some examples, if a user explicitly deletes a message from a chat (via a long press or the like), the group chat system 400a removes that message from the conversation history, since the user has instructed the group chat system 400a to delete the message.

In some examples, the group chat system 400a provides for ephemeral message storage in a short-term database and the message is automatically deleted by the group chat system 400a after a period of time. In some embodiments, the group chat system 400a stores messages in a long term datastore unless a user specifically asks to have the message deleted. In some examples, when a user deletes a message in the long term datastore, the message is also deleted in the short-term datastore.

In some examples, a chatbot mention and corresponding chatbot response are stored in a long term datastore and keyed by a user identification and deleting the chatbot mention and chatbot response is straight forward; however, deleting a chatbot mention and related chatbot response from a messaging datastore is more difficult as the chatbot mentions and chatbot responses may be dispersed throughout a set of stored messages of a message history of a user. In some examples, the group chat system 400a deletes all chatbot mentions and all chatbot responses across all conversations of a user in both short-term storage and long term storage. In some examples, the group chat system 400a enforces a message deletion policy wherein all conversations with the chatbot 344, except saved messages, are deleted. In response to receiving an explicit delete request from a user, the group chat system 400a deletes all chatbot mentions and chatbot responses from long term storage and deletes chatbot mentions and chatbot responses from a short-term message storage in accordance with a message deletion policy. For example, all text chats expire in 24 hours by default if all participants have read the messages and expire in 30 days regardless of whether participants have read the messages, except where any user has saved messages. In some examples, the group chat system 400a permits a user to delete their own chatbot mentions and corresponding chatbot responses on a per-chatbot mention and per-chatbot response basis. In some examples, the group chat system 400a permits a user to delete all chatbot mentions and chatbot responses where the chatbot mentions and chatbot responses are no longer being viewed by any user.

### Machine-Learning Pipeline

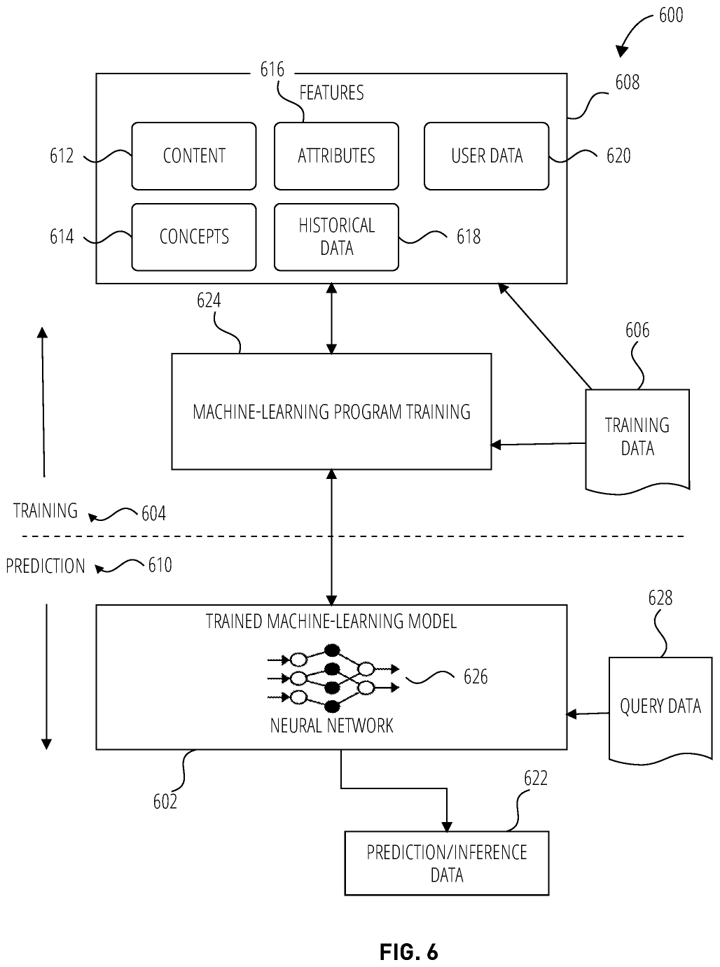

FIG. 6 is a flowchart depicting a machine-learning pipeline 600, according to some examples. The machine-learning pipeline 600 may be used to generate trained machine-learning model 602, such as the NLU component 320 (of FIG. 3A), the dialogue management component 318 (of FIG. 3A), and the generative AI model 340 (of FIG. 3A), to perform operations associated with searches and query responses.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

### Training Phases

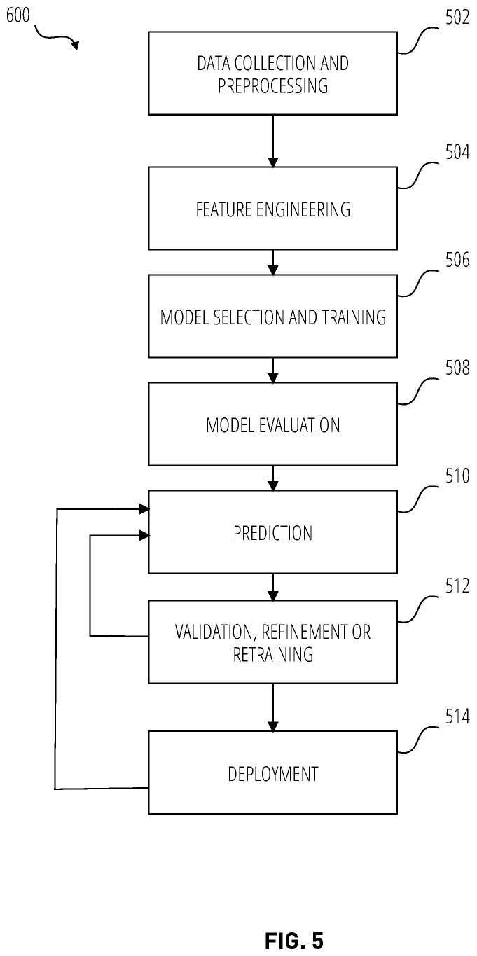

Generating a trained machine-learning model 602 may include multiple phases that form part of the machine-learning pipeline 600, including for example the following phases illustrated in FIG. 5:
Data collection and preprocessing 502: This phase may include acquiring and cleaning data to ensure that it is suitable for use in the machine learning model. This phase may also include removing duplicates, handling missing values, and converting data into a suitable format.
Feature engineering 504: This phase may include selecting and transforming the training data 606 to create features that are useful for predicting the target variable. Feature engineering may include (1) receiving features 608 (e.g., as structured or labeled data in supervised learning) and/or (2) identifying features 608 (e.g., unstructured or unlabeled data for unsupervised learning) in training data 606.
Model selection and training 506: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 508: This phase may include evaluating the performance of a trained model (e.g., the trained machine-learning model 602) on a separate testing dataset. This phase can help determine if the model is overfitting or underfitting and determine whether the model is suitable for deployment.
Prediction 510: This phase involves using a trained model (e.g., trained machine-learning model 602) to generate predictions on new, unseen data.
Validation, refinement or retraining 512: This phase may include updating a model based on feedback generated from the prediction phase, such as new data or user feedback.
Deployment 514: This phase may include integrating the trained model (e.g., the trained machine-learning model 602) into a more extensive system or application, such as a web service, mobile app, or IoT device. This phase can involve setting up APIs, building a user interface, and ensuring that the model is scalable and can handle large volumes of data.

FIG. 6 illustrates further details of two example phases, namely a training phase 604 (e.g., part of the model selection and trainings 506) and a prediction phase 610 (part of prediction 510). Prior to the training phase 604, feature engineering 504 is used to identify features 608. This may include identifying informative, discriminating, and independent features for effectively operating the trained machine-learning model 602 in pattern recognition, classification, and regression. In some examples, the training data 606 includes labeled data, known for pre-identified features 608 and one or more outcomes. Each of the features 608 may be a variable or attribute, such as an individual measurable property of a process, article, system, or phenomenon represented by a data set (e.g., the training data 606). Features 608 may also be of different types, such as numeric features, strings, and graphs, and may include one or more of content 612, concepts 614, attributes 616, historical data 618, and/or user data 620, merely for example.

In training phase 604, the machine-learning pipeline 600 uses the training data 606 to find correlations among the features 608 that affect a predicted outcome or prediction/inference data 622.

With the training data 606 and the identified features 608, the trained machine-learning model 602 is trained during the training phase 604 during machine-learning program training 624. The machine-learning program training 624 appraises values of the features 608 as they correlate to the training data 606. The result of the training is the trained machine-learning model 602 (e.g., a trained or learned model).

Further, the training phase 604 may involve machine learning, in which the training data 606 is structured (e.g., labeled during preprocessing operations). The trained machine-learning model 602 implements a neural network 626 capable of performing, for example, classification and clustering operations. In other examples, the training phase 604 may involve deep learning, in which the training data 606 is unstructured, and the trained machine-learning model 602 implements a deep neural network 626 that can perform both feature extraction and classification/clustering operations.

In some examples, a neural network 626 may be generated during the training phase 604, and implemented within the trained machine-learning model 602. The neural network 626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 610, the trained machine-learning model 602 uses the features 608 for analyzing query data 628 to generate inferences, outcomes, or predictions, as examples of a prediction/inference data 622. For example, during prediction phase 610, the trained machine-learning model 602 generates an output. Query data 628 is provided as an input to the trained machine-learning model 602, and the trained machine-learning model 602 generates the prediction/inference data 622 as output, responsive to receipt of the query data 628.

In some examples, the trained machine-learning model 602 may be a generative AI model. Generative AI is a term that may refer to any type of artificial intelligence that can create new content from training data 606. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 628 may include text, audio, image, video, numeric, or media content prompts and the output prediction/inference data 622 includes text, images, video, audio, code, or synthetic data.

### Data Architecture

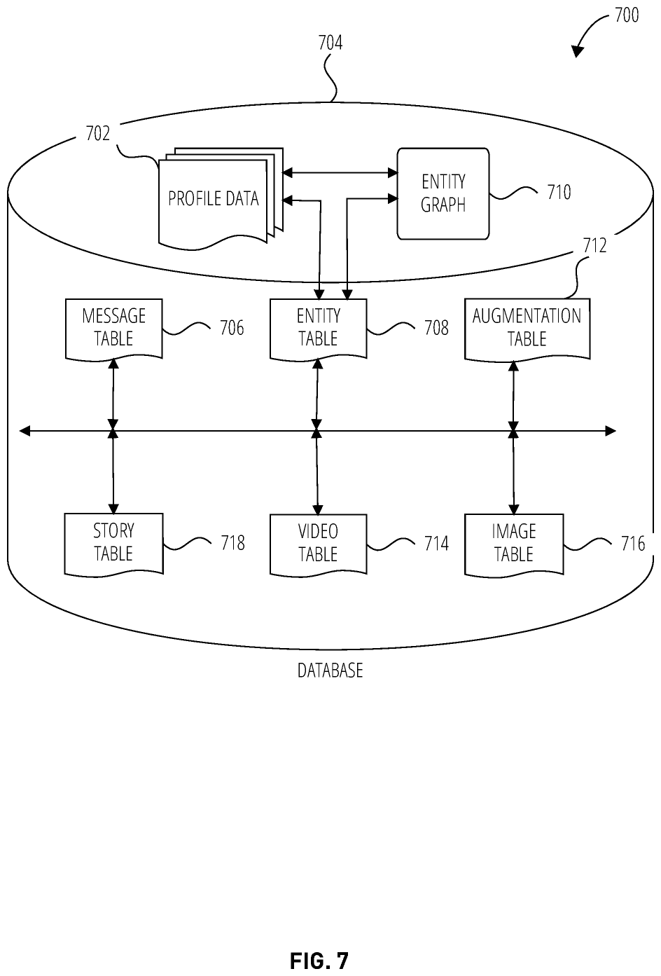

FIG. 7 is a schematic diagram illustrating data structures 700, which may be stored in the database 704 of the interaction server system 110, according to certain examples. While the content of the database 704 is shown to comprise multiple tables, it will be appreciated that the data could be stored in other types of data structures (e.g., as an object-oriented database).

The database 704 includes message data stored within a message table 706. This message data includes, for any particular message, at least message sender data, message recipient (or receiver) data, and a payload. Further details regarding information that may be included in a message, and included within the message data stored in the message table 706, are described below with reference to FIG. 7.

An entity table 708 stores entity data, and is linked (e.g., referentially) to an entity graph 710 and profile data 702. Entities for which records are maintained within the entity table 708 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 710 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interactive platform 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 708. Such privacy settings may be applied to all types of relationships within the context of the interactive platform 100, or may selectively be applied to only certain types of relationships.

The profile data 702 stores multiple types of profile data about a particular entity. The profile data 702 may be selectively used and presented to other users of the interactive platform 100 based on privacy settings specified by a particular entity. Where the entity is an individual, the profile data 702 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interactive platform 100, and on map interfaces displayed by interaction clients 104 to other users. The collection of avatar representations may include “status avatars,” which present a graphical representation of a status or activity that the user may select to communicate at a particular time.

Where the entity is a group, the profile data 702 for the group may similarly include one or more avatar representations associated with the group, in addition to the group name, members, and various settings (e.g., notifications) for the relevant group.

The database 704 also stores augmentation data, such as overlays or filters, in an augmentation table 712. The augmentation data is associated with and applied to videos (for which data is stored in a video table 714) and images (for which data is stored in an image table 716).

Filters, in some examples, are overlays that are displayed as overlaid on an image or video during presentation to a message receiver. Filters may be of various types, including user-selected filters from a set of filters presented to a message sender by the interaction client 104 when the message sender is composing a message. Other types of filters include geolocation filters (also known as geo-filters), which may be presented to a message sender based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a message sender by the interaction client 104 based on other inputs or information gathered by the user system 102 during the message creation process. Examples of data filters include current temperature at a specific location, a current speed at which a message sender is traveling, battery life for a user system 102, or the current time.

Other augmentation data that may be stored within the image table 716 includes augmented reality content items (e.g., corresponding to applying Lenses or augmented reality experiences). An augmented reality content item may be a real-time special effect and sound that may be added to an image or a video.

As described above, augmentation data includes augmented reality (AR), virtual reality (VR) and mixed reality (MR) content items, overlays, image transformations, images, and modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, a computer animation model to transform image data can be used by a system where a user may capture an image or video stream of the user (e.g., a selfie) using the user system 102 having a neural network operating as part of an interaction client 104 operating on the user system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the user system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 718 stores data regarding collections of messages and associated image, video, or audio data, which are compiled into a collection (e.g., a story or a gallery). The creation of a particular collection may be initiated by a particular user (e.g., each user for which a record is maintained in the entity table 708). A user may create a “personal story” in the form of a collection of content that has been created and sent/broadcast by that user. To this end, the user interface of the interaction client 104 may include an icon that is user-selectable to enable a message sender to add specific content to his or her personal story.

A collection may also constitute a “live story,” which is a collection of content from multiple users that is created manually, automatically, or using a combination of manual and automatic methodologies. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 714 stores video data that, in some examples, is associated with messages for which records are maintained within the message table 706. Similarly, the image table 716 stores image data associated with messages for which message data is stored in the entity table 708. The entity table 708 may associate various augmentations from the augmentation table 712 with various images and videos stored in the image table 716 and the video table 714.

The databases 704 also include entity relationship information collected by an interactive platform of an interactive platform 100. The entity relationship information may include without limitation relationship and communication data for users of the interactive platform. The entity relationship information can be used to group two or more users and offer additional functionality of the interactive platform 100. Examples of relationships include, but are not limited to, best friends relationships where two or more users are determined to be mutual best friends based on a frequency of their interactions, users who have common interests in current events, users who share an affiliation through social clubs or philanthropic organizations, and the like. Examples of communications include without limitation chats, private and public messages, exchanges of media such as images, videos, audio recordings, and the like.

### Data Communications Architecture

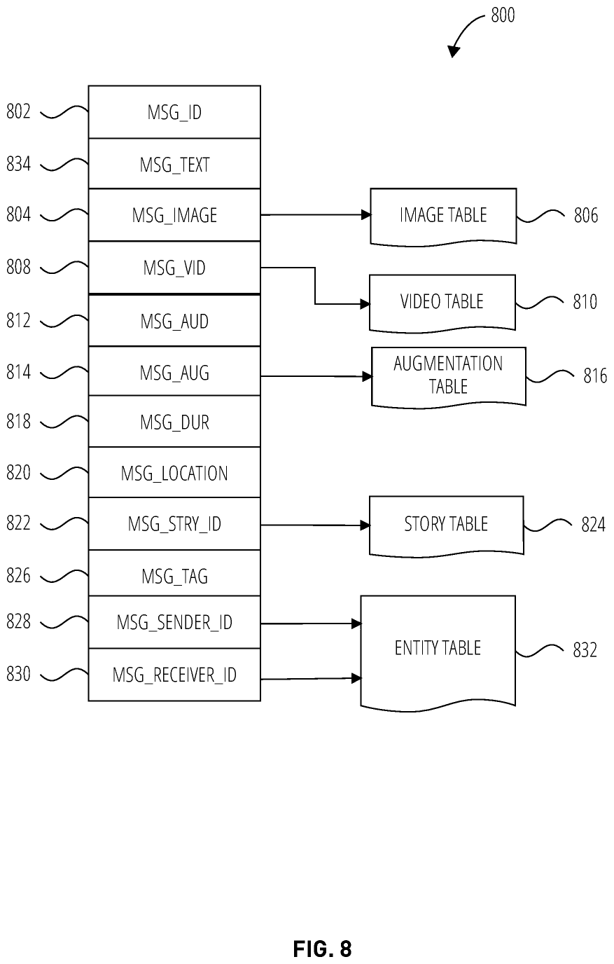

FIG. 8 is a schematic diagram illustrating a structure of a message 800, according to some examples, generated by an interaction client 104 for communication to a further interaction client 104 via the interaction servers 124. The content of a particular message 800 is used to populate the message table 706 stored within the database 704, accessible by the interaction servers 124. Similarly, the content of a message 800 is stored in memory as “in-transit” or “in-flight” data of the user system 102 or the interaction servers 124. A message 800 is shown to include the following example components:
Message identifier 802: a unique identifier that identifies the message 800.
Message text payload 834: text, to be generated by a user via a user interface of the user system 102, and that is included in the message 800.
Message image payload 804: image data, captured by a camera component of a user system 102 or retrieved from a memory component of a user system 102, and that is included in the message 800. Image data for a sent or received message 800 may be stored in the image table 806.
Message video payload 808: video data, captured by a camera component or retrieved from a memory component of the user system 102, and that is included in the message 800. Video data for a sent or received message 800 may be stored in the video table 810.
Message audio payload 812: audio data, captured by a microphone or retrieved from a memory component of the user system 102, and that is included in the message 800.
Message augmentation data 814: augmentation data (e.g., filters, stickers, or other annotations or enhancements) that represents augmentations to be applied to message image payload 804, message video payload 808, or message audio payload 812 of the message 800. Augmentation data for a sent or received message 800 may be stored in the augmentation table 816.
Message duration parameter 818: parameter value indicating, in seconds, the amount of time for which content of the message (e.g., the message image payload 804, message video payload 808, message audio payload 812) is to be presented or made accessible to a user via the interaction client 104.
Message geolocation parameter 820: geolocation data (e.g., latitudinal and longitudinal coordinates) associated with the content payload of the message. Multiple message geolocation parameter 820 values may be included in the payload, each of these parameter values being associated with respect to content items included in the content (e.g., a specific image within the message image payload 804, or a specific video in the message video payload 808).
Message story identifier 822: identifier values identifying one or more content collections (e.g., “stories” identified in the story table 824) with which a particular content item in the message image payload 804 of the message 800 is associated. For example, multiple images within the message image payload 804 may each be associated with multiple content collections using identifier values.
Message tag 826: each message 800 may be tagged with multiple tags, each of which is indicative of the subject matter of content included in the message payload. For example, where a particular image included in the message image payload 804 depicts an animal (e.g., a lion), a tag value may be included within the message tag 826 that is indicative of the relevant animal. Tag values may be generated manually, based on user input, or may be automatically generated using, for example, image recognition.
Message sender identifier 828: an identifier (e.g., a messaging system identifier, email address, or device identifier) indicative of a user of the user system 102 on which the message 800 was generated and from which the message 800 was sent.
Message receiver identifier 830: an identifier (e.g., a messaging system identifier, email address, or device identifier) indicative of a user of the user system 102 to which the message 800 is addressed.

The contents (e.g., values) of the various components of message 800 may be pointers to locations in tables within which content data values are stored. For example, an image value in the message image payload 804 may be a pointer to (or address of) a location within an image table 806. Similarly, values within the message video payload 808 may point to data stored within a video table 810, values stored within the message augmentation data 814 may point to data stored in an augmentation table 816, values stored within the message story identifier 822 may point to data stored in a story table 824, and values stored within the message sender identifier 828 and the message receiver identifier 830 may point to user records stored within an entity table 832.

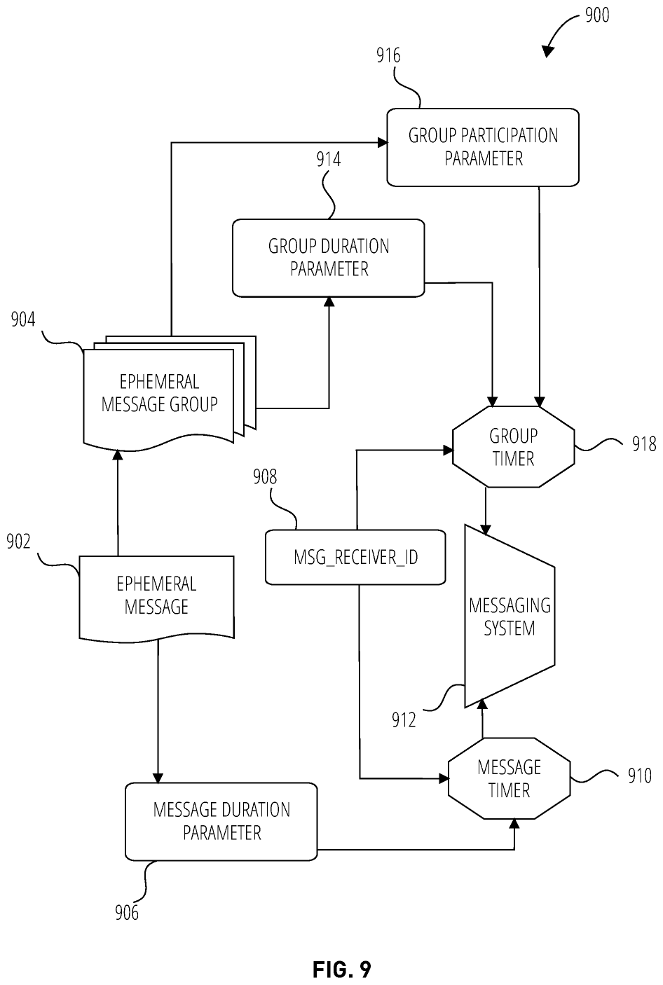

FIG. 9 is a schematic diagram illustrating an access-limiting process 900, in terms of which access to content (e.g., an ephemeral message 902 and associated multimedia payload of data) or a content collection (e.g., an ephemeral message group 904) may be time-limited (e.g., made ephemeral).

An ephemeral message 902 is shown to be associated with a message duration parameter 906, the value of which determines the amount of time that the ephemeral message 902 is displayed to a receiving user of the ephemeral message 902 by the interaction client 104. In some examples, an ephemeral message 902 is viewable by a receiving user for up to a maximum of 10 seconds, depending on the amount of time that the message sender specifies using the message duration parameter 906.

The message duration parameter 906 and the message receiver identifier 908 are shown to be inputs to a message timer 910, which is responsible for determining the amount of time that the ephemeral message 902 is shown to a particular receiving user identified by the message receiver identifier 908. In particular, the ephemeral message 902 is shown to the relevant receiving user for a time period determined by the value of the message duration parameter 906. The message timer 910 is shown to provide output to a more generalized messaging system 912, which is responsible for the overall timing of display of content (e.g., an ephemeral message 902) to a receiving user.

The ephemeral message 902 is shown in FIG. 9 to be included within an ephemeral message group 904 (e.g., a collection of messages in a personal story, or an event story). The ephemeral message group 904 has an associated group duration parameter 914, a value of which determines a time duration for which the ephemeral message group 904 is presented and accessible to users of the interactive platform 100. The group duration parameter 914, for example, may be the duration of a music concert, where the ephemeral message group 904 is a collection of content pertaining to that concert. Alternatively, a user (either the owning user or a curator user) may specify the value for the group duration parameter 914 when performing the setup and creation of the ephemeral message group 904.

Additionally, each ephemeral message 902 within the ephemeral message group 904 has an associated group participation parameter 916, a value of which determines the duration of time for which the ephemeral message 902 is accessible within the context of the ephemeral message group 904. Accordingly, a particular ephemeral message group 904 may “expire” and become inaccessible within the context of the ephemeral message group 904 prior to the ephemeral message group 904 itself expiring in terms of the group duration parameter 914. The group duration parameter 914, group participation parameter 916, and message receiver identifier 908 each provide input to a group timer 918, which operationally determines, firstly, whether a particular ephemeral message 902 of the ephemeral message group 904 is displayed to a particular receiving user and, if so, for how long. Note that the ephemeral message group 904 is also aware of the identity of the particular receiving user as a result of the message receiver identifier 908.

Accordingly, the group timer 918 operationally controls the overall lifespan of an associated ephemeral message group 904 as well as an individual ephemeral message 902 included in the ephemeral message group 904. In some examples, each and every ephemeral message 902 within the ephemeral message group 904 remains viewable and accessible for a time period specified by the group duration parameter 914. In a further example, a certain ephemeral message 902 may expire within the context of ephemeral message group 904 based on a group participation parameter 916. Note that a message duration parameter 906 may still determine the duration of time for which a particular ephemeral message 902 is displayed to a receiving user, even within the context of the ephemeral message group 904. Accordingly, the message duration parameter 906 determines the duration of time that a particular ephemeral message 902 is displayed to a receiving user regardless of whether the receiving user is viewing that ephemeral message 902 inside or outside the context of an ephemeral message group 904.

The messaging system 912 may furthermore operationally remove a particular ephemeral message 902 from the ephemeral message group 904 based on a determination that it has exceeded an associated group participation parameter 916. For example, when a message sender has established a group participation parameter 916 of 24 hours from posting, the messaging system 912 will remove the relevant ephemeral message 902 from the ephemeral message group 904 after the specified 24 hours. The messaging system 912 also operates to remove an ephemeral message group 904 when either the group participation parameter 916 for each and every ephemeral message 902 within the ephemeral message group 904 has expired, or when the ephemeral message group 904 itself has expired in terms of the group duration parameter 914.

In certain use cases, a creator of a particular ephemeral message group 904 may specify an indefinite group duration parameter 914. In this case, the expiration of the group participation parameter 916 for the last remaining ephemeral message 902 within the ephemeral message group 904 will determine when the ephemeral message group 904 itself expires. In this case, a new ephemeral message 902, added to the ephemeral message group 904, with a new group participation parameter 916, effectively extends the life of an ephemeral message group 904 to equal the value of the group participation parameter 916.

Responsive to the messaging system 912 determining that an ephemeral message group 904 has expired (e.g., is no longer accessible), the messaging system 912 communicates with the interactive platform 100 (and, for example, specifically the interaction client 104) to cause an indicium (e.g., an icon) associated with the relevant ephemeral message group 904 to no longer be displayed within a user interface of the interaction client 104. Similarly, when the messaging system 912 determines that the message duration parameter 906 for a particular ephemeral message 902 has expired, the messaging system 912 causes the interaction client 104 to no longer display an indicium (e.g., an icon or textual identification) associated with the ephemeral message 902.

### Machine Architecture

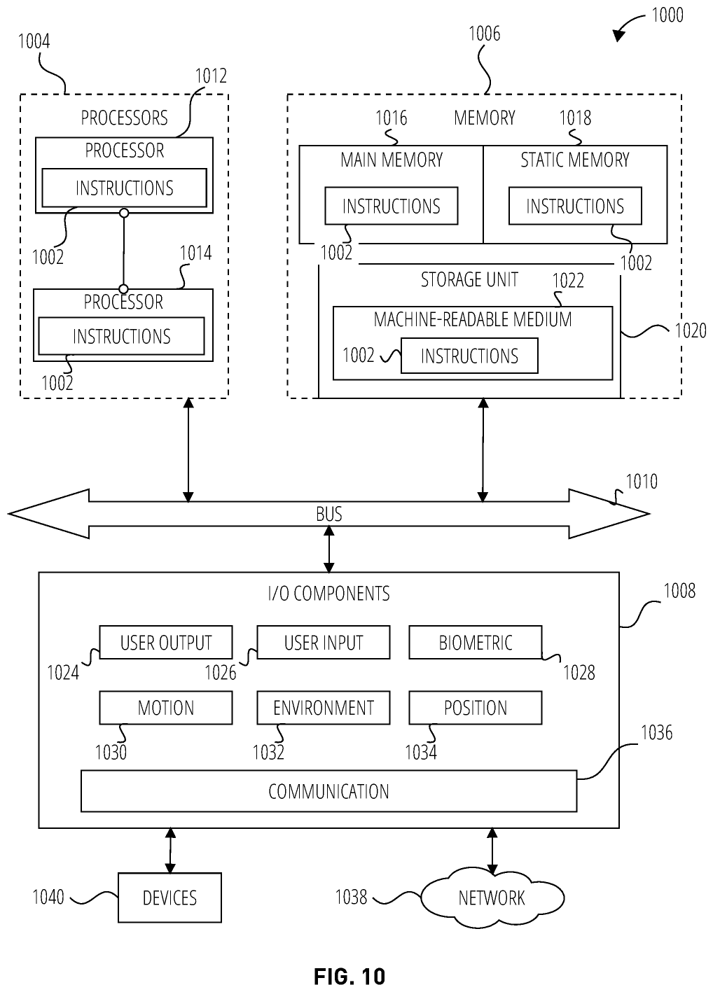

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the interaction server system 110. In some examples, the machine 1000 may also comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1030 include acceleration sensor components (e.g., accelerometer), gravitation sensor components, rotation sensor components (e.g., gyroscope). The biometric components may include a brain-machine interface (BMI) system that allows communication between the brain and an external device or machine. This is achieved by recording brain activity, translating it into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which involve surgically implanting electrodes directly into the brain.
Optogenetics BMIs, which use light to control the activity of specific nerve cells in the brain.
Functional magnetic resonance imaging (fMRI)-based BMIs, which use magnetic fields to measure blood flow in the brain, which can be used to infer brain activity.

Any BMI data collected by an interactive platform is captured and stored only with user approval and deleted on user request. Further, such data may be used for very limited purposes, such as identity verification or user input. To ensure limited and authorized use of BMI data and other personally identifiable information (PII), access to this BMI data is restricted to authorized personnel only, if at all. Any use of BMI data may strictly be limited to a designated purpose, and the BMI data is not shared or sold to any third party without the explicit consent of the user. In addition, appropriate technical and organizational measures are implemented to ensure the security and confidentiality of this sensitive information.

The environmental components 1032 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

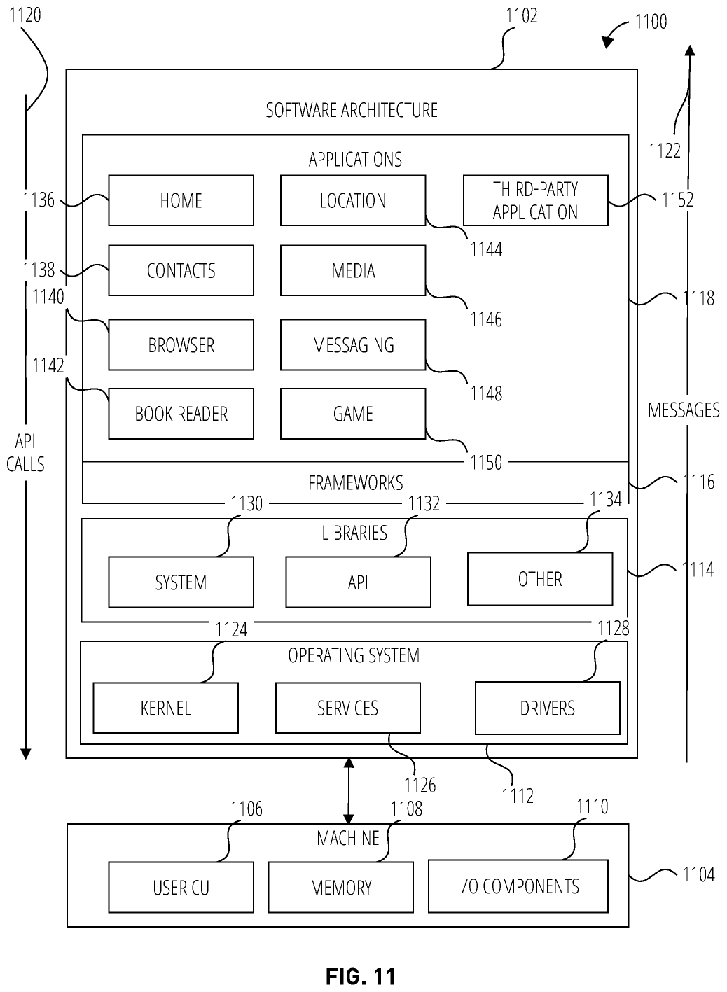

FIG. 11 is a block diagram 1100 illustrating a software architecture 1102, which can be installed on any one or more of the devices described herein. The software architecture 1102 is supported by hardware such as a machine 1104 that includes user cu 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein. Additional examples include:

Example 1 is a method comprising: receiving, by one or more processors, a chatbot mention message from a user system of a user in a group chat session, the chatbot mention message comprising a chatbot prompt created by the user; generating, by the one or more processors, a prompt using the chatbot mention message; generating, by the one or more processors, a chatbot response message using the prompt; and providing, by the one or more processors, the chatbot response message to one or more other user systems of one or more other users in the group chat session.

Example 2 is the method of Example 1, further comprising: storing, by the one or more processors, one or more stored chatbot mention messages and one or more stored chatbot response messages associated with the user; and generating a context for the prompt using the one or more stored chatbot mention messages and the one or more stored chatbot response messages.

Example 3 is the method of any of Examples 1-2, further comprising: in response to receiving, by the one or more processors, a delete message request from the user, deleting the one or more stored chatbot mention messages and the one or more stored chatbot response messages.

Example 4 is the method of any of Examples 1-3, wherein deleting the one or more stored chatbot mention messages and the one or more chatbot prompt messages comprises immediately deleting the one or more stored chatbot mention messages and the one or more chatbot prompt messages from a short-term datastore, and deleting the one or more stored chatbot mention messages and the one or more chatbot prompt messages from a long term datastore using a message deletion policy.

Example 5 is the method of any of Examples 1-4, wherein the one or more stored chatbot mention messages and the one or more stored chatbot response messages are associated with two or more users in the group chat session, and wherein the method further comprises generating, by the one or more processors, a context for the prompt for each user of the group chat session using the one or more stored chatbot mention messages and the one or more stored chatbot response messages.

Example 6 is the method of any of Examples 1-5, further comprising: in response to determining, by the one or more processors, that the chatbot mention message is a first chatbot mention message in the group chat session, providing a chatbot notification describing an operation of the chatbot to one or more users in the group chat session.

Example 7 is the method of any of Examples 1-6, wherein generating the response comprises generating the response using a persona of the chatbot.

Example 8 is at least one machine-readable medium including instructions that, when executed by processing circuitry, cause the processing circuitry to perform operations to implement any of Examples 1-7.

Example 9 is an apparatus comprising means to implement any of Examples 1-7.

Example 10 is a system to implement any of Examples 1-7.

### Conclusion

Changes and modifications may be made to the disclosed examples without departing from the scope of the present disclosure. These and other changes or modifications are intended to be included within the scope of the present disclosure.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

In this disclosure and appended claims, the terms “a” or “an” are used, as is common in patent documents, to include one or more than one, independent of any other instances or usages of “at least one” or “one or more.” In this disclosure and appended claims, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the appended claims, the terms “including” and “comprising” are open-ended; that is, a system, device, article, or process that includes elements in addition to those listed after such a term in a claim is still deemed to fall within the scope of that claim.

What is claimed is:

1. A method comprising:
receiving, by one or more processors, a chatbot mention message from a user system of a user in a group chat session, the chatbot mention message comprising a chatbot prompt created by the user;
generating, by the one or more processors, a prompt using the chatbot mention message;
generating, by the one or more processors, a chatbot response message using the prompt; and
providing, by the one or more processors, the chatbot response message to one or more other user systems of one or more other users in the group chat session.

2. The method of claim 1, further comprising:
storing, by the one or more processors, one or more stored chatbot mention messages and one or more stored chatbot response messages associated with the user; and
generating a context for the prompt using the one or more stored chatbot mention messages and the one or more stored chatbot response messages.

3. The method of claim 2, further comprising:
in response to receiving, by the one or more processors, a delete message request from the user, deleting the one or more stored chatbot mention messages and the one or more stored chatbot response messages.

4. The method of claim 3, wherein deleting the one or more stored chatbot mention messages and the one or more chatbot prompt messages comprises immediately deleting the one or more stored chatbot mention messages and the one or more chatbot prompt messages from a short-term datastore, and deleting the one or more stored chatbot mention messages and the one or more chatbot prompt messages from a long term datastore using a message deletion policy.

5. The method of claim 2,
wherein the one or more stored chatbot mention messages and the one or more stored chatbot response messages are associated with two or more users in the group chat session, and
wherein the method further comprises generating, by the one or more processors, a context for the prompt for each user of the group chat session using the one or more stored chatbot mention messages and the one or more stored chatbot response messages.

6. The method of claim 1, further comprising:
in response to determining, by the one or more processors, that the chatbot mention message is a first chatbot mention message in the group chat session, providing a chatbot notification describing an operation of the chatbot to one or more users in the group chat session.

7. The method of claim 1, wherein generating the response comprises generating the response using a persona of the chatbot.

8. A machine, comprising:
one or more processors; and
one or more memories storing instructions that, when executed by the one or more processors, cause the machine to perform operations comprising:
receiving a chatbot mention message from a user system of a user in a group chat session, the chatbot mention message comprising a chatbot prompt created by the user;
generating a prompt using the chatbot mention message;
generating a chatbot response message using the prompt; and
providing the chatbot response message to one or more other user systems of one or more other users in the group chat session.

9. The machine of claim 8, wherein the operations further comprise:
storing one or more stored chatbot mention messages and one or more stored chatbot response messages associated with the user; and
generating a context for the prompt using the one or more stored chatbot mention messages and the one or more stored chatbot response messages.

10. The machine of claim 9, wherein the operations further comprise:
in response to receiving a delete message request from the user, deleting the one or more stored chatbot mention messages and the one or more stored chatbot response messages.

11. The machine of claim 10, wherein deleting the one or more stored chatbot mention messages and the one or more chatbot prompt messages comprises immediately deleting the one or more stored chatbot mention messages and the one or more chatbot prompt messages from a short-term datastore, and deleting the one or more stored chatbot mention messages and the one or more chatbot prompt messages from a long term datastore using a message deletion policy.

12. The machine of claim 9,
wherein the one or more stored chatbot mention messages and the one or more stored chatbot response messages are associated with two or more users in the group chat session, and
wherein the operations further comprise:
generating, by the one or more processors, a context for the prompt for each user of the group chat session using the one or more stored chatbot mention messages and the one or more stored chatbot response messages.

13. The machine of claim 8, wherein the operations further comprise:
in response to determining that the chatbot mention message is a first chatbot mention message in the group chat session, providing a chatbot notification describing an operation of the chatbot to one or more users in the group chat session.

14. The machine of claim 8, wherein generating the response comprises generating the response using a persona of the chatbot.

15. A machine-storage medium storing executable instructions that, when executed by a machine, cause the machine to perform operations comprising:
receiving a chatbot mention message from a user system of a user in a group chat session, the chatbot mention message comprising a chatbot prompt created by the user;
generating a prompt using the chatbot mention message;
generating a chatbot response message using the prompt; and
providing the chatbot response message to one or more other user systems of one or more other users in the group chat session.

16. The machine-storage medium of claim 15, wherein the operations further comprise:
storing one or more stored chatbot mention messages and one or more stored chatbot response messages associated with the user; and
generating a context for the prompt using the one or more stored chatbot mention messages and the one or more stored chatbot response messages.

17. The machine-storage medium of claim 16, wherein the operations further comprise:
in response to receiving a delete message request from the user, deleting the one or more stored chatbot mention messages and the one or more stored chatbot response messages.

18. The machine-storage medium of claim 17, wherein deleting the one or more stored chatbot mention messages and the one or more chatbot prompt messages comprises immediately deleting the one or more stored chatbot mention messages and the one or more chatbot prompt messages from a short-term datastore, and deleting the one or more stored chatbot mention messages and the one or more chatbot prompt messages from a long term datastore using a message deletion policy.

19. The machine-storage medium of claim 16,
wherein the one or more stored chatbot mention messages and the one or more stored chatbot response messages are associated with two or more users in the group chat session, and
wherein the operations further comprise generating a context for the prompt for each user of the group chat session using the one or more stored chatbot mention messages and the one or more stored chatbot response messages.

20. The machine-storage medium of claim 15, wherein the operations further comprise:
in response to determining that the chatbot mention message is a first chatbot mention message in the group chat session, providing a chatbot notification describing an operation of the chatbot to one or more users in the group chat session.
